(19) United States
(12) Patent Application Publication
(10) Pub. No.: US 2010/0211652 A1
(43) Pub. Date: Aug. 19, 2010

(54) DATA SHARING NETWORK DEVICE HAVING PORTABLE STORAGE PORTION WITH NETWORK FUNCTION

(76) Inventor: Shih-Ho Hong, Taipei (TW)

Correspondence Address: DING YU TAN, Chengde Road, Sec 1, #83, 3F-1, Taipei, TW

(21) Appl. No.: 12/773,010

(22) Filed: May 3, 2010

Related U.S. Application Data
(63) Continuation-in-part of application No. 11/704,444, filed on Feb. 12, 2007, now Pat. No. 7,743,213.

(30) Foreign Application Priority Data
Nov. 24, 2006 (TW) 095143624

(51) Int. Cl. G06F 12/02; G06F 17/30; G06F 21/00; G06F 21/22; G06F 15/16

(52) U.S. Cl. 709/217; 711/115; 711/103; 707/827; 726/24; 726/17; 707/E17.032; 711/E12.008; 711/E12.002

(57) ABSTRACT

A data sharing network device includes a portable storage portion with network function, which has a network file management system, via which an electronic apparatus coupled to the portable storage portion manages the access of files between a memory unit of the portable storage portion with network function and a remote network host. The portable storage portion with network function includes an interface portion, a network unit for linking with the remote network host, the memory unit and a processing unit for controlling data access between the memory unit and the electronic apparatus via the interface portion, between the memory unit and a remote network host, and between the memory unit and another memory unit of another portable storage portion with network function in which data can be stored on the remote network host, on the memory unit, or on the electronic device.

### CROSS REFERENCE TO RELATED TO RELATED APPLICATION

This application is a continuation-in-part of an U.S. application Ser. No. 11/704,444, filed 12 Feb. 2007, now pending, which is based on, and claims the priority benefit of Taiwan application serial no. 095143624, filed on 24 Nov. 2006. The contents of each of the above-mentioned patent applications are hereby incorporated by reference herein in its entirety and made a part of this specification.

### FIELD OF THE INVENTION

The present invention relates to a data sharing network device including an electronic apparatus and a portable storage portion with network function, and more particularly to a portable storage portion with network function, so that an electronic apparatus integrated with the portable storage portion with network function may manage the access of files between a memory unit of the portable storage portion and a remote network host, between the data sharing network device comprising the memory unit and an another electronic apparatus, or between the data sharing network device and an another memory unit of an another data sharing network device.

### BACKGROUND OF THE INVENTION

In many of the currently adopted manners of data processing and data storage, data to be stored is either stored in a personal computer, such as a desktop computer, a notebook computer, or a personal digital assistant (PDA), or in a remote server by linking a personal computer with the remote server via a network. When it is desired to use the disk space in the remote server as a virtual disk of the personal computer, it is necessary to set a relevant driver for the personal computer. Since such setting of driver is computer-specific, a user without carrying about that particular driver in the computer just could not use the virtual network disk drive.

In addition, due to recent popularity and widespread adoption of wireless electronic devices such as mobile phones, smart phones, 3G smart phones, electronic reader, touch sensitive tablet devices, and portable electronic game devices, to name a few, vast amounts of data are being gathered and stored in various network electronic devices, therefore, there is a need to collaborate, share, and synchronize these data located in different electronic devices by linking each of the electronic device with a remote server via a network. When an user desires to collaborate, share, and synchronize these separately-located data, a network file management system provided in one portable storage portion with network function can serve to manage the data access between the memory unit of that portable storage portion integrated in one data sharing network device with a remote network host or with other memory units integrated in other portable storage portions with network function in other data sharing network devices.

There is therefore a need to develop a data sharing network device including a portable storage portion with network function to overcome the limitations when using conventional electronic apparatuses or portable storage devices, so that an electronic apparatus integrated with the portable storage portion with network function may manage the access of files between a memory unit of the portable storage portion and a remote network host or the memory unit of another portable storage portion via a network file management system, making the portable storage portion with network function more convenient for use.

### SUMMARY OF THE INVENTION

An object of the present invention is to provide a data sharing network device which includes a portable storage portion with network function that is integrated with an electronic apparatus.

Another object of the present invention is to provide a portable storage portion, into which network function is incorporated, so that an electronic apparatus coupled to or integrated with the portable storage portion with network function may manage the access of files between a memory unit of the portable storage portion and a remote network host or the memory unit of another portable storage portion belonging to another data sharing network device.

For a desktop computer or a mobile electronic apparatus, such as a notebook computer, a mobile phone, an electronic reader device, or a PDA, the portable storage portion with network function according to the present invention is compatible with an operating system supporting mass storage without the need of requiring additional drivers, and may have a storage capacity much larger than other currently available conventional portable data storage devices.

To achieve the above and other objects, the portable storage portion with network function according to the present invention includes an interface portion for for integrating with an electronic apparatus; a network unit for linking with a remote network host; a memory unit for providing access of data; and a processing unit that receives instructions of the electronic apparatus to control the access of data between the memory unit and the electronic apparatus via the interface portion, and the access of data between the memory unit and the linked remote network host or between the memory unit and another memory unit via the network unit.

Therefore, it is possible to access files located in a remote network host or from another portable storage portion with network function via the electronic apparatus and a network file management system residing either in the portable storage portion or the electronic apparatus, making the portable storage portion with network function more convenient for use.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 shows a configuration of a portable storage portion with network function according to the present invention;

FIG. 2 shows a preferred example of application of the portable storage portion with network function according to the present invention in a wireless network system; and

FIG. 3 shows a preferred example of application of the portable storage portion with network function according to the present invention in a wired network system.

### DETAILED DESCRIPTION OF THE PREFERRED EMBODIMENTS

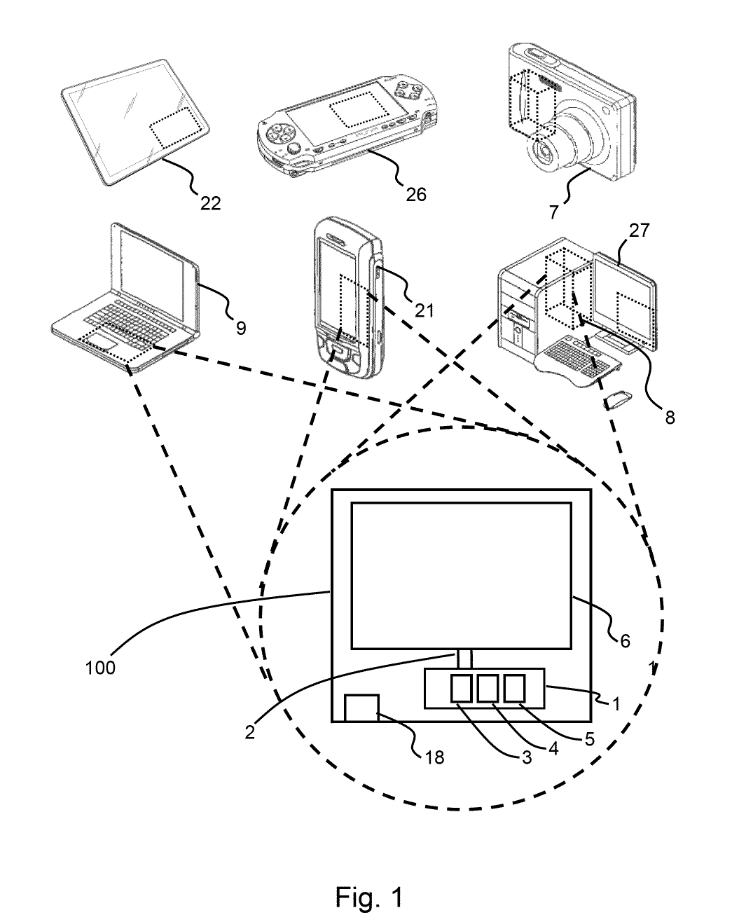

Please refer to FIG. 1 that shows a configuration of a data sharing network device 100 which includes an electronic apparatus 6, a portable storage portion with network function 1, and an interface portion 2 according to a first embodiment. In this embodiment, the interface portion 2 may include, but is not limited to a flexible circuit board, a connector, a plurality of wire bonding, flip chip bonding, and other conventional integrated circuit assembly technologies. The electronic apparatus 6, includes, but is not limited to, a digital camera 7, a desktop computer 8, a notebook computer 9, a PDA (not shown), an MP3 player (not shown), or a voice pen (not shown), a mobile phone 21, a computer tablet device 22, an electronic reader device (not shown), a cable TV set-top box (not shown), a portable game device 26, a speaker system (not shown), and a liquid crystal display 27. The portable storage portion with network function 1 includes also a network unit 3, which may be a wired-network chip or a wireless-network chip and also may be located within the portable storage portion with network function 1, or instead is located outside of and coupled to the portable storage portion 1, for linking with a remote network host or a virtual hard disk. And the remote network host can also be further coupled to another portable storage portion with network function 1 in another data sharing network device 100, so that the two portable storage portions with network function 1 can thereby effectively communicate; and a memory unit 4 providing access of data; and a processing unit 5, which may include, but not limited to, a SOC (System on chip) configuration.

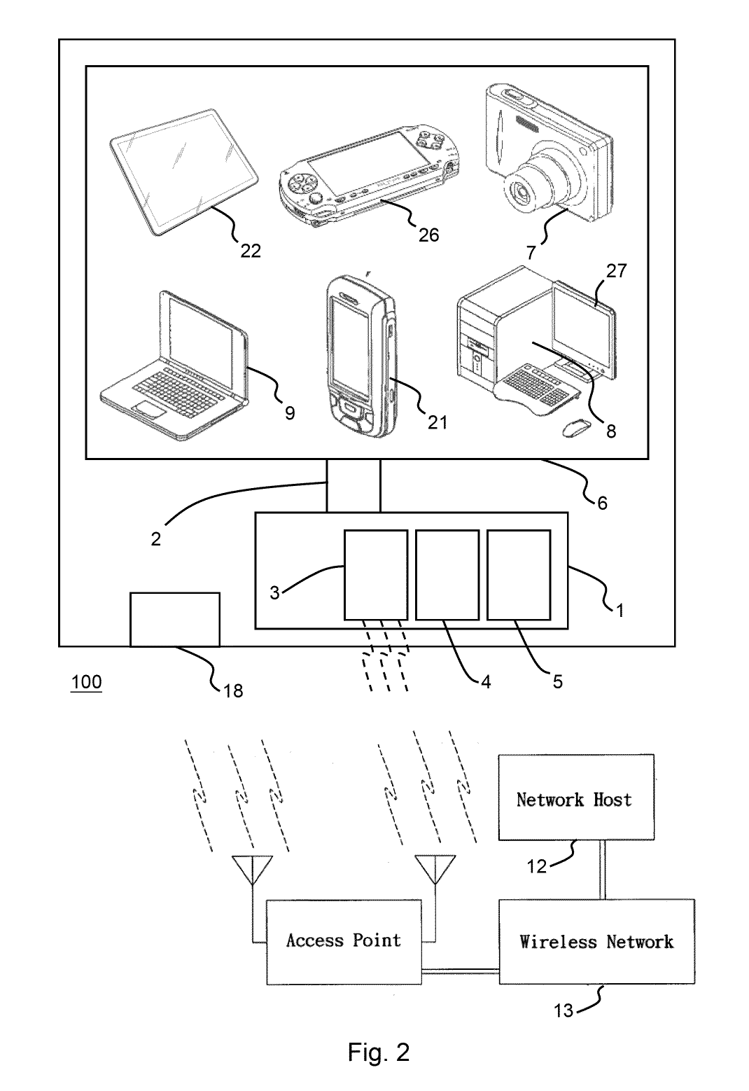

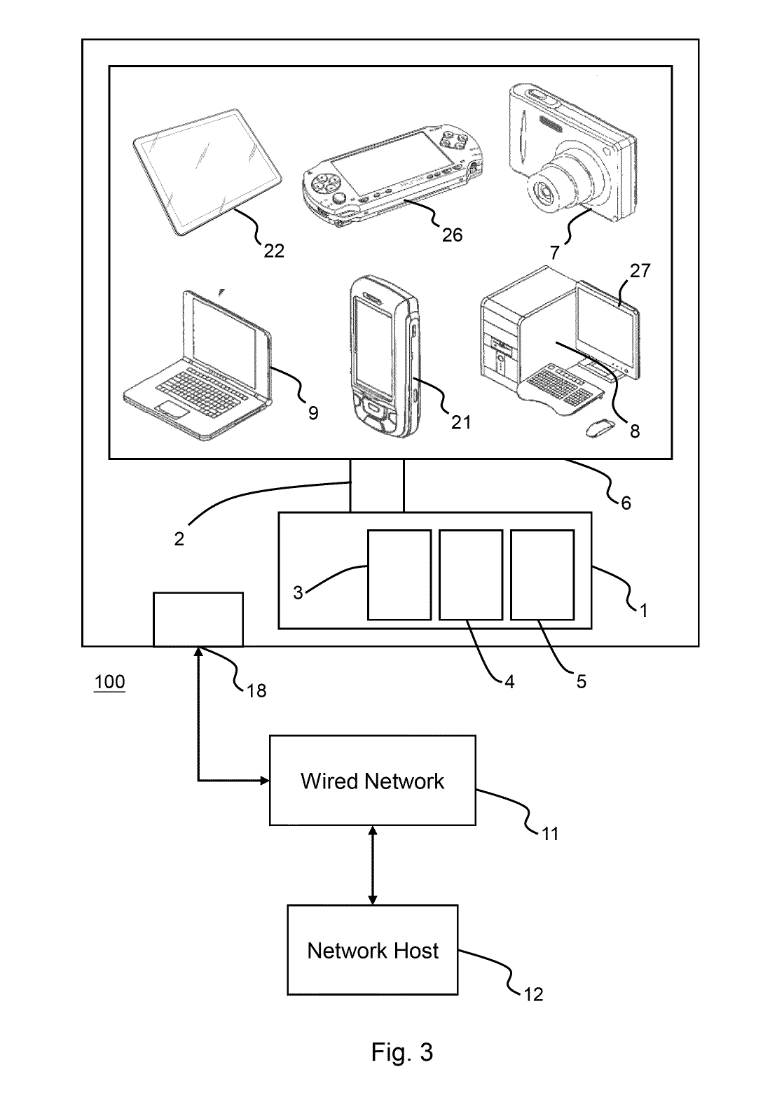

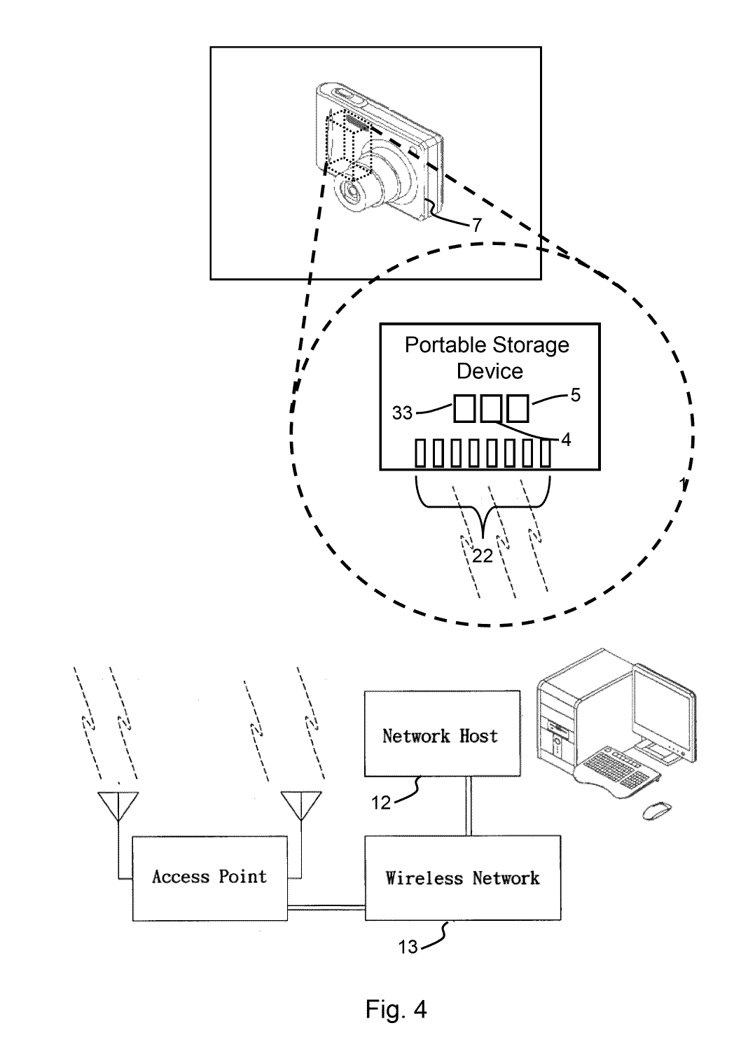

FIGS. 2 and 3 show preferred examples of application of the portable storage portion with network function 1 in a wireless network system and a wired network system, respectively. As shown, the portable storage portion with network function 1 is integrated with the electronic apparatus 6, including but not limited to the digital camera 7, the personal computer 8, the notebook computer 9, the PDA (not shown), the MP3 player, the mobile phone 21, the computer tablet device 22, the electronic reader device (not shown), the portable game device 26, the speaker system (not shown), the liquid crystal display 27 or the voice pen (not shown), so that the processing unit 5 inside the portable storage portion with network function 1 receives instructions from the electronic apparatus 6 for controlling access of data between the memory unit 4 and the electronic apparatus 6, access of data between the memory unit 4 and a remote network host 12 or a virtual hard disk, and access of data between the memory unit 4 and another memory unit 4 residing on the another electronic apparatus 6 through the remote network host 12, both of which are linked with the portable storage portion with network function 1 via a wired network 11 as shown in FIG. 3 or a wireless network 13 as shown in FIG. 2. In the wired network system, data is transmitted via an interface unit 18, and in the wireless network system, data is transmitted via the network unit 3 to an access point of the wireless network 13. The wireless network 13 can be in the form of a Wi-Fi broadband network, a cellular network, a 3G or 4G wireless network, a home wireless router network, etc. . . . The interface unit 18 may be, for example, in the form of an USB interface, an SD interface, a CF interface, an XD interface, a PCMCIA interface, a 1394 interface, an infrared interface, and a Bluetooth interface. The electronic apparatus 6 uses the network file management system (not shown) provided in the portable storage portion 1 to manage the data access between the memory unit 4 and the electronic apparatus 6 or between the memory unit 4 and the remote network host 12 or the virtual hard disk, or data access between the memory unit 4 of one data sharing network device 100 and another memory unit 4 of another data sharing network device 100 through the remote network host 12. In the present invention, the portable storage portion with network function 1 may further include the function of an MP2 player (not shown) or a voice pen (not shown).

As an example, the use of the portable storage portion with network function 1 with a digital camera 7 is now further described. In an environment with a wireless network, when the digital camera 7 is coupled to or integrated with the portable storage portion with network function 1, photos taken by using the digital camera 7 may be directly stored on the remote network host 12 or the virtual hard disk via the wireless network. Therefore, the available storage capacity of the digital camera 7 may be effectively increased. On the other hand, when the digital camera 7 is used in an environment without any available network, the photos having been taken may be temporarily stored on the portable storage portion with network function 1. The photos stored inside the portable storage portion 1 may be transmitted to and stored on the remote network host 12 or the virtual hard disk or to even another portable storage portion with network function 1 integrated with another electronic apparatus 6 or digital camera 7 through the remote network host 12 as soon as a network environment is available.

As another example, the use of the portable storage portion with network function 1 with one or more computers is now further described. With the portable storage portion with network function 1, computer operation may be executed at any place on any computer or electronic apparatus 6 by having one computer or the electronic apparatus 6 integrated with the portable storage portion with network function 1 by mean of the interface portion 2, and the computer or data or multimedia data files may be stored on the remote network host 12 or on an another computer which is also integrated with the portable storage portion 1. The user can then link together the data sharing network device 100 which has the portable storage portion with network function 1 with the remote network host 12 through the interface unit 18, such as an USB interface, located on the computer integrated with the portable storage portion 1. In this manner, a user need not carry a clumsy notebook computer around, and would not be restricted or limited to a specific computer to use the remote network host 12 for accessing data stored on a plurality of computers which are integrated with the portable storage portions 1. Because all of the linked computers are comprised of integrated portable storage portions 1, therefore, operational functions such as data access rights, data network security management, user authentication and password management, data traffic control, user web interface for file sharing content management capable of real-time viewing of content information among all of linked computers, data buffering management, managing user requests to and from computers to the remote network host 12, and tracking of user data usage status at each computer integrated with the portable storage portion 1 are also provided.

Please refer to FIG. 4 that shows a configuration of a portable storage device with network function which includes an interface unit 22, a network unit 33, a memory unit 4, and a processing unit 5. The interface unit 22 may be a microSD 8-pin interface or a SDHC 9-pin interface depending upon the type and format of the portable storage device with network function being used. The network unit 33 may be an integrated IEEE 802.11 g/n WI-FI unit which operates on a 2.4 GHz band wireless network 13. The memory unit 4 may be in the form of a conventional SDHC memory card, for example. The processing unit 5, which may include, but not limited to a SOC (system on chip) configuration. The interface unit 22 is removably connected to the electronic apparatus 6 such as the digital camera 7 inside the SDHC memory card slot of the camera 7. The network unit 33 is fully integrated to provide the portable storage device with wireless broadband internet capabilities for automatically linking with a wireless access point. The wireless access point maybe be a conventional wireless router which is located in close proximity from the portable storage device such as within 20 meters. In addition, the network unit 33 can then be wirelessly linked to a remote network host 12, such as, for example, in the form of a desktop PC, upon turning on the camera 7 which has the portable storage device being coupled. The memory unit 4 is located within the portable storage device, and is used for providing access of image and video data and temporary data storage of image and video data received from the camera 7. In this embodiment, data is directly automatically stored on the remote network host 12 upon the configuration of a data sharing management software program. The data sharing management software program has a conventional graphic user interface. An user can decide upon the exact manner in which the data downloaded from the portable storage device with network function to the remote network host 12 is to be shared with one or more of the internet multimedia data hosting sites such as Flickr® or Youtube® or Facebook®, for example by using the above data sharing management software program.

The foregoing description has been directed to specific embodiments of this invention. It will be apparent, however, that other variations and modifications may be made to the described embodiments, with the attainment of some or all of their advantages. For example, it should be understood that the portable storage portion could be separated or being apart from the network function portion, wherein the network function portion could reside in the integrated electronic apparatus itself, an example would be for instance, a cell phone or wireless phone. Here, the network function portion then becomes part of the electronic apparatus itself to form a network or communication electronic device. Another possible modification can be the replacement of the interface portion 2 with an interface unit 18 described in the first embodiment in FIG. 1 that shows a configuration of a data sharing network device 100. In this modified embodiment, the interface unit 18 may include, but is not limited to an USB interface, an SD interface, a CF interface, an XD interface, a PCMCIA interface, a 1394 interface, an infrared interface, and a Bluetooth interface. Therefore, it is the object of the appended claims to cover all such variations and modifications as come within the true spirit and scope of the invention.

What is claimed is:

1. A data sharing network device, comprising:
an electronic apparatus; and
a portable storage portion with network function, and the portable storage portion with network function, comprising:
an interface portion or an interface unit for integrating or coupling the portable storage portion with network function to an electronic apparatus, respectively;
a network unit located within the portable storage portion with network function for linking with a remote network host;
a memory unit located within the portable storage portion with network function providing access of data and storing data receiving from the electronic apparatus; and
a processing unit located within the portable storage portion with network function that receives instructions from the electronic apparatus for controlling access of data between the memory unit and the electronic apparatus with data transmission via the interface portion or the interface unit, access of data between the memory unit and a remote network host with data transmission via the network unit, and access of data between the memory unit and a second electronic apparatus with data transmission via the network unit through the remote network host wherein data is stored on the remote network host, the memory unit, or the memory unit located within the portable storage portion with network function integrated with the second electronic apparatus.

2. The data sharing network device as claimed in claim 1 further comprising an interface unit, wherein operating under a wired network system, the data is transmitted via an interface unit, and the data sharing network device is linked together with the remote network host through the interface unit.

3. The data sharing network device as claimed in claim 1, wherein operating under a wireless network system, the data is transmitted via the network unit, and the data sharing network device is linked together with the remote network host through the network unit.

4. The data sharing network device as claimed in claim 1, wherein the interface unit is selected from the group consisting of USB interface, an SD interface, a CF interface, an XD interface, a PCMCIA interface, a 1394 interface, an infrared interface, and a Bluetooth interface.

5. A portable storage portion with network function, comprising:
an interface portion for integrating the portable storage portion with network function to an electronic apparatus;
a network unit located within the portable storage portion with network function for linking with a remote network host;
a memory unit located within the portable storage portion with network storage function providing access of data and storing data receiving from the electronic apparatus; and
a processing unit located within the portable storage portion with network function that receives instructions from the electronic apparatus for controlling access of data between the memory unit and the electronic apparatus with data transmission via the interface portion, and access of data between the memory unit and a remote network host with data transmission via the network unit wherein data is stored on the remote network host, or on the memory unit.

6. The portable storage portion with network function as claimed in claim 5, wherein the memory unit has an operating system stored therein.

7. The portable storage portion with network function as claimed in claim 5, wherein the operating system includes a network driving unit for driving the network unit.

8. The portable storage portion with network function as claimed in claim 5, wherein the operating system includes an interface driving unit for driving the interface portion.

9. The portable storage portion with network function as claimed in claim 5, wherein the operating system includes a network file management system, via which the electronic apparatus manages the access of data between the memory unit and the electronic apparatus, and between the memory unit and the remote network host.

10. The portable storage portion with network function as claimed in claim 5, wherein the operating system includes a system security unit for protecting the operating system against computer virus infection.

11. The portable storage portion with network function as claimed in claim 5, wherein the operating system includes an authentication unit for authenticating at least one user.

12. The portable storage portion with network function as claimed in claim 5, wherein the interface portion is selected from the group consisting of a flexible circuit board, a connector, a plurality of wire bonds, and a flip chip bonding.

13. The portable storage portion with network function as claimed in claim 5, wherein the electronic apparatus is selected from the group consisting of a digital camera, a personal computer, a notebook computer, a PDA, a phone, a computer tablet device, an electronic reader device, a portable game device, a speaker system, and a liquid crystal display.

14. The portable storage portion with network function as claimed in claim 5, wherein the network unit is selected from the group consisting of a wired network chip and a wireless network chip.

15. The portable storage portion with network function as claimed in claim 5, wherein the processing unit comprises a SOC (system on chip) configuration.

16. The portable storage portion with network function as claimed in claim 5, wherein the authentication unit conducts authentication in a manner selected from the group consisting of password authentication, fingerprint authentication, and voice authentication.

17. A portable storage portion with network function, comprising:
an interface portion for coupling to a first electronic apparatus;
a network unit coupled to the portable storage portion for linking with a remote network host; the remote network host transfer data between the portable storage portion with network function and a second electronic apparatus;
a memory unit located within the portable storage portion providing access of data and storing data receiving from the first electronic apparatus; and
a processing unit located within the portable storage portion that receives instructions from the first electronic apparatus for controlling access of data between the memory unit and the first electronic apparatus with data transmission via the interface portion, and access of data between the memory unit and a remote network host with data transmission via the network unit, wherein data is stored on the remote network host or on the memory unit.

18. A data sharing network device, comprising:
an electronic apparatus;
a network unit located outside the data sharing network device for linking with a remote network host; and
a portable storage portion, and the portable storage portion, comprising:
an interface portion for integrating the portable storage portion to an electronic apparatus;
a memory unit located within the portable storage portion providing access of data and temporarily storing data receiving from the electronic apparatus; and
a processing unit that receives instructions from the electronic apparatus for controlling access of data between the memory unit and the electronic apparatus with data transmission via the interface portion, access of data between the memory unit and a remote network host with data transmission via the network unit, and access of data between the memory unit and a second electronic apparatus with data transmission via the network unit through the remote network host wherein data is stored on the remote network host, the memory unit, or the memory unit located within the portable storage portion integrated with the second electronic apparatus.

19. A portable storage device with network function, comprising:
an interface unit;
one or more outside memory units, the outside memory units are coupled to the portable storage device with network function through the interface unit;
a network unit coupled to the portable storage device with network function through the interface unit for linking with the internet;
a memory unit located within the portable storage device providing access of data and temporarily storing data receiving from the one or more electronic apparatuses accessible from the internet and the one or more outside memory units; and
a processing unit located within the portable storage device that receives instructions from the internet through the network unit via a web browser for controlling access of data between the memory unit and the one or more electronic apparatuses with data transmission via the network unit, and access of data between the memory unit and the one or more outside memory units with data transmission via the interface unit,
wherein data is stored on the outside memory unit, and the portable storage device with network function is removably coupled to the electronic apparatuses through the internet, and the portable storage device with network function transfer data between the outside memory units and the electronic apparatuses through the internet.

20. A portable storage device with network function, comprising:
an interface unit for coupling the portable storage portion to a first electronic apparatus;
a network unit is coupled to the portable storage unit using the interface unit for linking with the internet;
a memory unit located within the portable storage device providing access of data and temporarily storing data receiving from the first electronic apparatus; and
a processing unit located within the portable storage device that receives instructions from a second electronic apparatus for controlling access of data between the memory unit and the second electronic apparatus with data transmission via the interface unit, wherein data from the first electronic apparatus is directly stored on the memory unit and is transferred from the memory unit to the network unit; and the data is then transferred from the network unit through the internet to the second electronic apparatus in real time; the portable storage device with network function is removably coupled to the first electronic apparatus.

21. A portable storage device with network function, comprising:
an interface unit for coupling to an electronic apparatus;
a network unit located within the portable storage device for automatically wirelessly linking with a remote network host through the internet upon turning on the electronic apparatus;
a memory unit located within the portable storage device providing access of data and temporarily storing data receiving from the electronic apparatus; and
a processing unit located within the portable storage device that receives instructions from the electronic apparatus for controlling access of data between the memory unit and the electronic apparatus with data transmission via the interface unit, and access of data between the memory unit and a remote network host with data transmission via the network unit, wherein data is directly automatically stored on the remote network host upon the configuration of a data sharing management software program on the remote network host, and the data is then transferable to one or more internet multimedia data hosting websites through the use of the data sharing management software program; the portable storage device with network function is removably coupled to the electronic apparatus, expanding storage capacity of the electronic apparatus.
